(19) United States
(12) Patent Application Publication
(10) Pub. No.: US 2011/0082724 A1
(43) Pub. Date: Apr. 7, 2011

(54) SYSTEM AND METHOD FOR ADVERTISEMENT PLACEMENT IN AN ELECTRONIC READER DEVICE

(75) Inventors: Vincent LE CHEVALIER, San Jose, CA (US); Brady Duga, Carlsbad, CA (US); Garth Conboy, La Jolla, CA (US); William Leshner, San Diego, CA (US); John Rivlin, Palo Alto, CA (US); Ruze Richards, Holmdel, NJ (US)

(73) Assignee: FIRSTPAPER LLC, New York, NY (US)

(21) Appl. No.: 12/575,009

(22) Filed: Oct. 7, 2009

(51) Int. Cl. G06Q 30/00; G06F 17/30; G06F 7/10

(52) U.S. Cl. 705/14.4; 707/758; 707/E17.107

(57) ABSTRACT

A system for and method for placement of advertisement content at an electronic reader device is presented. The system and method comprise an acquisition module configured to receive via a network a plurality of first electronic content from a first source and a plurality of second electronic content from a second source, wherein the plurality of first electronic content includes a first electronic content map and the plurality of second electronic content includes a second electronic content map, a storage module configured to store the plurality of first electronic content and the plurality of second electronic content, a selection module configured to select at least some of the plurality of first electronic content and the plurality of second electronic content for presentation, and a presentation module configured to present the selected electronic content at the electronic reader device according to at least one of the first electronic content map and the second electronic content map.

### BACKGROUND INFORMATION

A traditional newspaper is typically printed on large sheets of paper. Large sheets of paper allow multiple news items and other content (e.g., editorials, reviews, etc.) to be effectively shared with various advertising content. Because advertisements represent a large revenue stream, the amount of available space or “real estate” for placing advertisements is particularly valuable. As this traditional blend of newspaper content is shifted to newer electronic formats, fitting advertisements and/or reformatting newspaper content within each electronic page is important. In a web-style newspaper page, topical links and scrolling features are used for navigating multiple news items and advertisements. However, in electronic readers, a pagination feature rather than a scrolling feature is used for navigation. Because of this and other unique features of electronic reader devices, optimizing advertisement placement and presentment within an electronic page having at least a paginated navigation feature becomes important. Conventional systems and methods do not provide a technique for optimizing advertisement placement and presentment in an electronic reader device.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements.

FIG. 1 depicts a block diagram of a system for content distribution, according to an exemplary embodiment.

FIG. 2 depicts a module for presenting and placing content at an electronic device, according to an exemplary embodiment.

FIG. 3 depicts an illustrative page metadata map configuration for an electronic device, according to an exemplary embodiment.

FIG. 4 depicts an illustrative advertisement metadata map configuration for an electronic device, according to an exemplary embodiment.

FIG. 5 depicts an illustrative flowchart for presenting and placing content at an electronic device, according to an exemplary embodiment.

### DETAILED DESCRIPTION

Certain embodiments of the present invention provide electronic content access management on an electronic display device. More particularly, certain embodiments of the present invention provide a system for and method of managing electronic content access. Such electronic content may be accessed, by way of non-limiting example, via a device utilizing an electronic paper display (referred to herein as “EPD”), such as electrophoretic displays or electro-wetting displays. Examples of such displays include those disclosed in U.S. Pat. Nos. 6,577,433, 6,529,313, 6,525,866, 6,574,034, 6,017,584, 6,067,185, 6,118,426, 6,120,839, 6,124,851, 6,130,774, 6,172,798, 6,177,921, 6,232,950 and 6,249,271.

As page real estate begins to shrink to fit smaller electronic paper formats, original content may not adequately scaled to fit within a given electronic page (e.g., image sizes, story sizes, etc.). For example, a full-sized advertisement typically presented in a traditional newspaper would not be able to fit, preserving its actual dimensions and size, within the confines of a much smaller portable handheld electronic device. Therefore, web-style pages provide features, such as links and vertical scrolling, to present such newspaper content. Optimizing an electronic page for presenting and placing advertisement content, without significant size alterations or dimension distortions, becomes important especially for electronic reader devices, which may not use similar web-style navigation features.

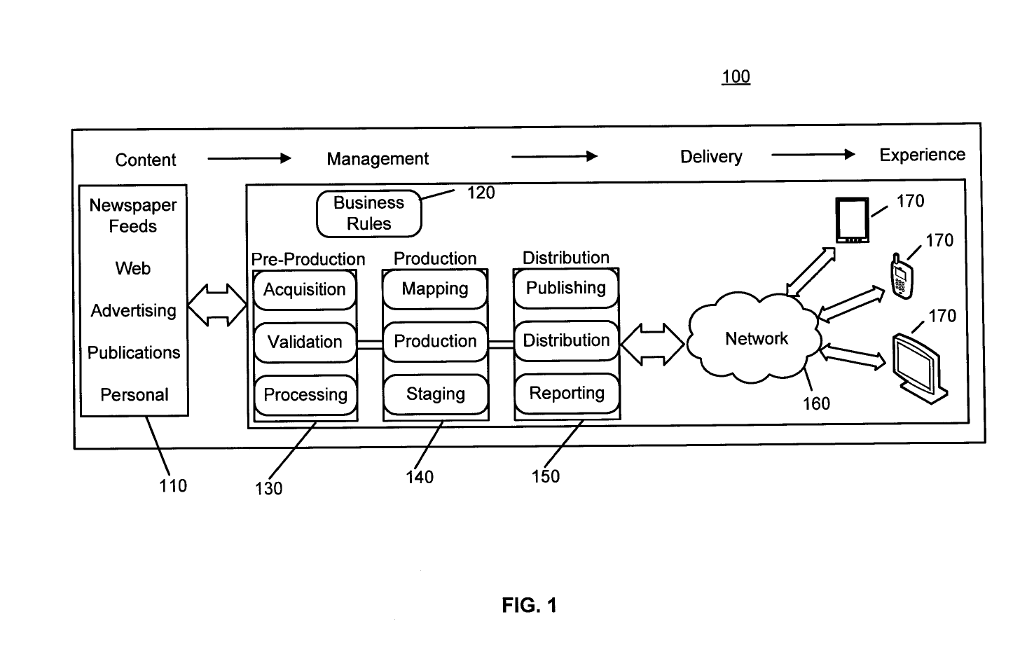

FIG. 1 depicts a block diagram of a system for content distribution, according to an exemplary embodiment. In some embodiments, the system 100 may by a content distribution system (CDN), which may include a content management system 110, a business rules system 120, a pre-production system 130, a production system 140, a distribution system 150 and one or more electronic devices 170. The distribution system 150 may distribute content to the one or more electronic devices 170 over a communications network 160. The communications network 160 may be any wired or wireless network. In one embodiment, the communication network may be an Internet Protocol (IP)-based network.

The content management system 110 may be communicatively coupled to the pre-production system 130, which in turn may be communicatively coupled to the production system 140. The production system 140 may be communicatively coupled to the distribution system 150. In some embodiments, content may be aggregated at the content management system 110 and outputted to the pre-production system 130 for validation and/or processing. The processed content may then be outputted from the pre-production system 130 and received at the production system 140 for mapping and/or staging. The mapped and staged content may then be outputted from the production system 140 and received at the distribution system 150 for publishing and/or distribution to the one or more electronic devices 170 over the communications network 160.

The pre-production system 130 may receive sourced content from the content management system 110 and output processed content to the production system 140. The production system 140 may received the processed content and output staged content to the distribution system 150. The distribution system 150 may receive the staged content and output approved content to one or more of the electronic devices 170.

The content management system 110 may include logic for gathering, aggregating, managing and/or storing content of various types. The types of content may include newspaper feeds, web content, advertising, publications, and/or personal information. In some embodiments, the content management system 110 may be configured to gather and/or aggregate content from one or more sources, categories, and/or content partners to the CDN 100 that provide content in association with the CDN 100. In some embodiments, the content may be gathered and/or aggregated automatically. In other embodiments, the content management system 110 may gather and/or aggregate the content based on one or more criteria. The criteria may include whether the content is perishable, curated, on-line, personal and/or other criteria. It should be appreciated that the content management system 110 may receive advertisement content from external advertisement providers and/or other third party sources.

The business rules system 120 may include a workflow engine configured to manage and/or execute modeled business processes. Each step in the operation of the workflow engine may be indicative of one or more business rules. The workflow engine may perform one or more actions based on the one or more business rules indicative of a specific template associated with a feed and/or publication in which content is received at the content management system 110. For example, in some embodiments, the one or more business rules may be completed for each article, publication, and/or advertisement processed through the workflow engine. In various embodiments, the business rules system 120 may include a workflow engine that operates according to one or more of the following rules: content enters the system through the feed, content is stored in a content repository (such as the content management system 110), various validation rules may be executed on the content, various pre-production rules are executed (the results of which may be stored back in the content management system 110), various production rules are executed (the results of which may be stored back in the content management system 110), and the distribution system 150 may receive the results of the production system and distribute to electronic devices 170. In one embodiment, the CDN 100 may operate according to an amalgamation of the one or more business rules 120 as applied through the workflow engine.

Information relating to displayed content and/or related user actions may also be used by the business rules system 120 and/or other modules associated with electronic content distribution to enhance content delivery and presentment. It should be appreciated that various content received from the content management system 110 may be formatted according to the business rules system 120 at pre-production system 130, production system 140, and/or distribution system 150.

Exemplary content distribution networks are disclosed in U.S. application Ser. No. 12/248,482, titled “Systems, Methods and Apparatus for Content Distribution,” filed on Oct. 9, 2008 and U.S. provisional application No. 60/978,748, titled “Content Distribution and Preloading,” filed on Oct. 9, 2007, both of which are hereby incorporated by reference in their entireties.

It should be appreciated that the components/systems of the CDN 100 may be servers, network storage devices or other devices communicatively coupled to the communication network 160. In one or more embodiments, components/systems of the CDN 100 may perform any, or a combination, of storing, receiving, transmitting, producing, aggregating, and/or uploading electronic content. The components/systems of the CDN 100 may also perform other electronic content management functionality including, but not limited to, any, or a combination, of account management, electronic payment processing and verification, target marketing of electronic content to electronic display device users, user electronic content tracking, and content distribution.

In some embodiments, the components/systems of the CDN 100 may contain or be communicatively coupled to storage, such as a redundant array of inexpensive disks (RAID), a storage area network (SAN), an interne small computer systems interface (iSCSI) SAN, a Fibre Channel SAN, a common Internet File System (CIFS), network attached storage (NAS), a network file system (NFS), tape drive based storage, or other computer accessible storage.

Additionally, components/systems of the CDN 100 may communicate with any, or a combination, of other systems, applications, and storage locations directly via one or more of an Application Programming Interface (API), a Remote Procedure Call (RPC), an interface table, a web service, an Extensible Markup Language (XML) based interface, a Simple Object Access Protocol (SOAP) based interface, a common request broker architecture (CORBA) based interface, and other interfaces for sending or receiving information. For example, components/systems of the CDN 100 may communicate with accounting systems, marketing systems, interactive voice response (IVR) systems, systems of content providers, or other systems, servers, or components to facilitate electronic content caching and transactions.

Components/systems of the CDN 100 may each be responsible for different functionality in an electronic content distribution network. By way of non-limiting example, the components/systems of the CDN 100 may produce, receive, organize and aggregate electronic content, such as periodicals, books, newsletters, or other electronic content. Such electronic content may be aggregated from one or more feeds, such as publishers, resellers, newspapers, journalists, news services, broadcasts, or other sources. Processing of electronic content may include any, or a combination, of indexing, categorizing, storing, formatting, translating, filtering, spell checking, compressing, encrypting, securing, replicating, and further processing. Electronic content may be produced by user or third-party input (e.g., blogs, newsletters, etc.). Such content may be input via, by way of non-limiting example, typed input or dictations processed by speech to text input (e.g., text of speeches, conferences, proceedings, hearings, etc.). Electronic content may be produced by scanning existing text, such as by way of non-limiting example, by Optical Character Recognition (OCR) processes. Other scanning processes may produce electronic content without performing OCR processes. The components/systems of the CDN 100 may translate content from one format to another. For example, The components/systems of the CDN 100 may receive content from a subscriber and may translate the content into one or more electronic formats including, but not limited to, proprietary formats utilized by one or more e-book readers. The components/systems of the CDN 100 may receive subscriber or user content via emails, FTP (File Transfer Protocol), HTTP (Hyper Text Transfer Protocol), text message (e.g., via Short Message Service (SMS)), Multi-Media Messaging Service (MMS), Wireless Access Protocol (WAP), or via other electronic communication protocols. Categorization of content by the components/systems of the CDN 100 may include any, or a combination, of organizing content, storing content, and indexing content by one or more of a subject, subscription, and access. By way of non-limiting example, content may be grouped or stored in databases or other storage which may be separated according to subscription.

The network 160 may be any network, such as a local area network (LAN), a wide area network (WAN), a service provider network, the Internet, or other similar network. In some embodiments, the network 160 may be a service provider network. It should be appreciated that the network may use electric, electromagnetic, and/or optical signals that carry digital data streams.

The one or more electronic devices 170 may be electronic book (e-book) readers and/or E-Ink® devices. In other embodiments, the one or more electronic devices 170 may be desktop computers, laptops/notebooks, servers or server-like systems, modules, Personal Digital Assistants (PDAs), smart phones, cellular phones, mobile phones, satellite phones, MP3 players, video players, personal media players, personal video recorders (PVR), watches, gaming consoles/devices, navigation devices, televisions, printers, and/or other devices capable of receiving and/or transmitting signals and/or displaying electronic content. It should be appreciated that the network element 102 may be mobile, handheld, or stationary. It should also be appreciated that the one or more electronic devices 170 may be used independently or may be used as an integrated component in another device and/or system.

In some embodiments, electronic display devices 170 may access electronic content locally via one or more device interfaces. For example, the one or more electronic devices 170 may transmit and receive data to and from network 160 utilizing a standard telecommunications protocol or a standard networking protocol. By way of non-limiting example, one embodiment may utilize FTP (File Transfer Protocol), HTTP (Hyper Text Transfer Protocol), Wireless Application Protocol (WAP), Multimedia Messaging Service (MMS), Enhanced Messaging Service (EMS), Short Message Service (SMS), Global System for Mobile Communications (GSM) based systems, Transmission Control Protocol/Internet (TCP/IP) Protocols, or other protocols or systems suitable for transmitting and receiving electronic content data. Electronic content may be transmitted and received wirelessly or may utilize cabled network or telecom connections such as an Ethernet RJ45/Category 5 connection, a fiber connection, a traditional phone wireline connection, a cable connection or other wired network connection. The one or more electronic devices 170 may use standard wireless protocols including IEEE 802.11 and 802.16. The one or more electronic devices 170 may also be connected to network 102 via protocols for a wired connection, such as an IEEE Ethernet 802.3.

By way of non-limiting example, the one or more electronic devices 170 may also contain one or more interfaces including a USB (Universal Serial Bus) connection, an RS-232 or serial connection, a Bluetooth connection, an RFID (Radio Frequency IDentification) reader or interrogator, an RFID tag (active or passive), a firewire connection, or interfaces supporting storage media (e.g., flash memory cards, CDs, DVDs). Electronic content may be received by an end user on electronic storage media and may be loaded onto or accessed by an electronic display device via one or more interfaces.

It should also be appreciated that while the components/systems of the CDN 100 are shown as separate components, these may be combined into greater or lesser components to optimize flexibility. For example, while the content management system 110, pre-production system, production system 140, and distribution system 150 are depicted as separate components/systems, it should be appreciated that these components/systems may be integrated into a single component. Other various embodiments may also be realized.

It should be appreciated that each of the components/systems of the CDN 100 may be physical and/or virtual servers, modules, storage, devices, systems, etc. Each of the components/systems of the CDN 100 may also communicate with each other via one or more network communications. Other various embodiments may also be provided.

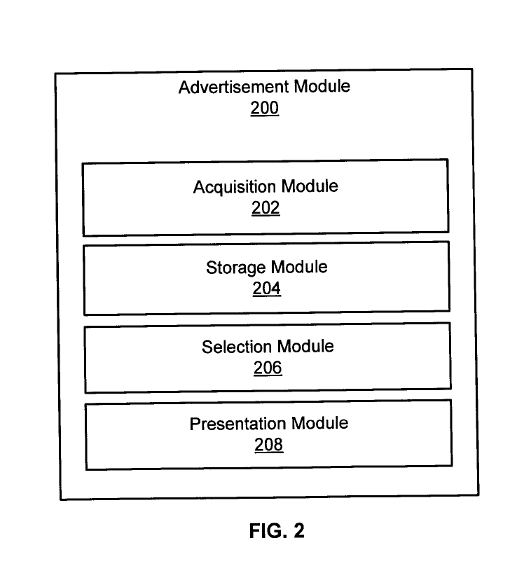

FIG. 2 depicts a module for presenting and placing content at an electronic device, according to an exemplary embodiment. The module may be an advertisement module 200. The advertisement module 200 may be a part of the content management system 110, the pre-production system 130, the production system 140, the distribution system 150, and/or the one or more electronic devices of the CDN 100. The advertisement module 200 may implemented in hardware, software, or a combination thereof.

The advertisement module 200 may include a variety of other components/modules, such as an acquisition module 202, a storage module 204, a selection module 206, a presentation module 208, and/or other modules. The acquisition module 202 may receive a plurality of electronic content from one or more content sources. For example, the acquisition module 202 may receive newspaper, book, web, and/or other publication content. The acquisition module 202 may also receive electronic advertisement content, which, for example, may be inserted within the newspaper, book, web, and/or other publication content. The storage module 204 may store the received electronic content. The selection module 206 may select at least some of the plurality of electronic content for presentation. The presentation module 208 may present the selected electronic content at an electronic device.

In one or more embodiments, the advertisement module 200 may ultimately present and place electronic content by using one or more page metadata maps and/or one or more advertisement metadata maps.

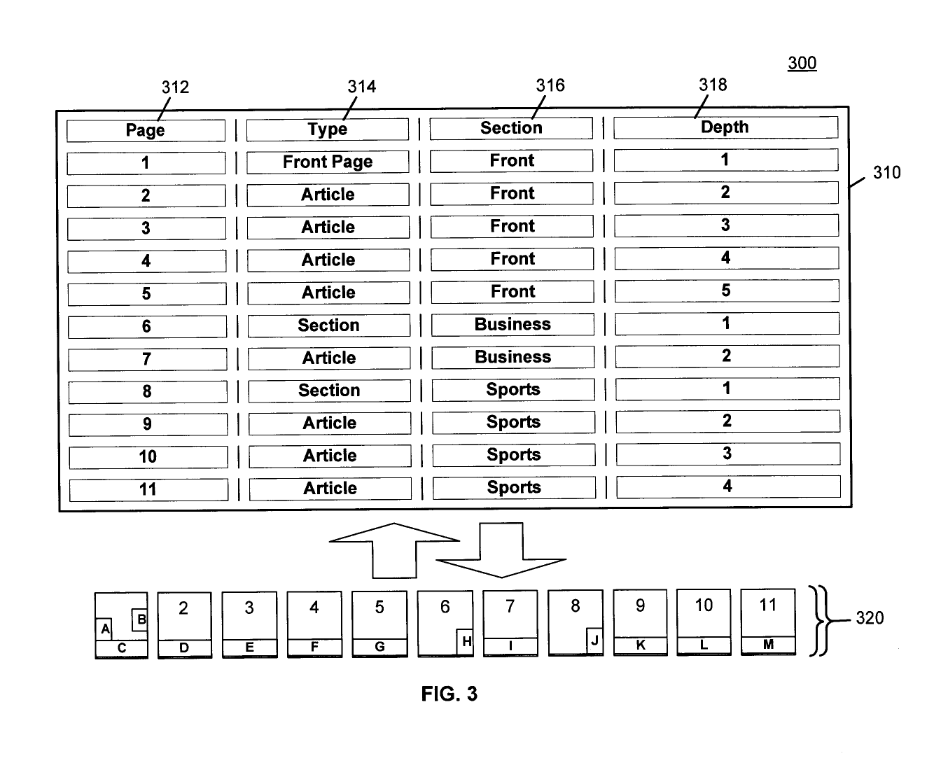

FIG. 3 depicts an illustrative page metadata map configuration 300 for an electronic device 170 (e.g., an electronic reader device), according to exemplary embodiments. In this embodiment, for example, electronic content may to be presented at the electronic device 170 may be electronic newspaper content. The electronic newspaper content may be designed, formatted, and/or otherwise configured by one or more components of the CDN 100 to fit within a screen of an electronic reader device. If the content does not all fit within the screen of the electronic reader device, the electronic newspaper content may be paginated and/or reformatted to fit in one or more pages. In other words, a user of the electronic reader device may view the newspaper content on the electronic device without scrolling up and down each page (e.g., via a sidebar scroller used in web-style pages). Instead, the user may, for example, simply hit a “next page” tab/button on the screen and/or electronic reader device to view the subsequent paginated electronic content.

When electronic content is paginated, for example, a page metadata map 310 may be provided. It should be appreciated that the term “pagination,” as herein described, may refer to content that is displayed in one full page or screen of an electronic reader device without a need to scroll to view any content portion. In this example, the page metadata map 310 may include several categories of information. In a newspaper embodiment, these may include page number 312, type of content 314, section of electronic newspaper 316, and depth 318.

In the page metadata map 310, the page number 312 may indicate there are eleven (11) pages for this particular electronic content item. The type of content 314 for this electronic newspaper may include “Front Page,” “Article,” and “Section.” The section 316 for the electronic newspaper may include “Front,” “Business,” and “Sports.” The depth of the content 318 may show how each page is collated or sequenced. It should be appreciated that one or more other categories of information may also be provided, especially for other types of electronic content, such as books, publications, etc.

The page metadata map 310 may correspond to paginated electronic content 320 to be viewed on a screen of the electronic reader device 170. In this example, the paginated electronic content 320 may depict each of the eleven (11) pages corresponding to the page metadata map 310. The page metadata map 310 may be useful for the advertisement module 200 to utilize an advertisement metadata map for advertisements.

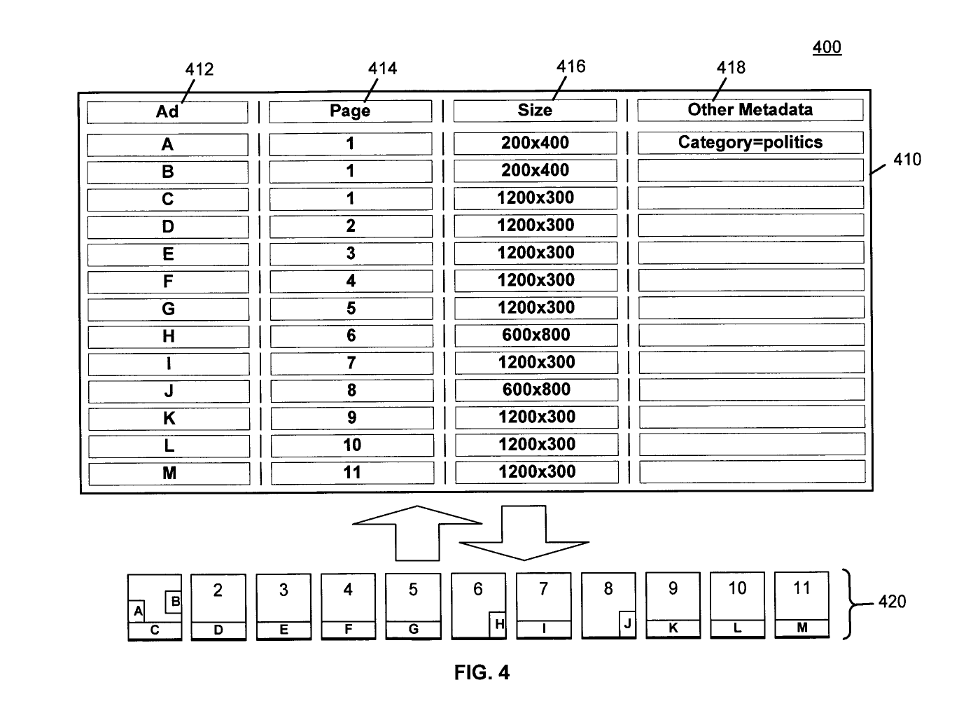

FIG. 4 depicts an illustrative advertisement metadata map configuration 400 for an electronic device 170 (e.g., an electronic reader device), according to exemplary embodiments. Similar to the page metadata map 310 of FIG. 3, the advertisement metadata map 410 may include several categories as well. For example, these may include advertisement number 412, page number 414, size of advertisement 416, and/or other metadata 418.

In the page metadata map 410, the advertisement number 412 may indicate a list of advertisements to be presented along with electronic content. In this example, there are thirteen (13) advertisements to be presented and/or placed, e.g., “A” through “M.” The page number 312 may indicate where each of these advertisements are to be placed, e.g., which page of the eleven page newspaper content. For example, advertisements A, B, and C may also be placed on page 1 of the electronic content. The size of each advertisement 316 may also be provided in the advertisement metadata map 410. Other metadata may also be included, such as the category/type of the advertisement, which may be particularly useful in targeting users/readers or for matching content with advertisements.

The advertisement metadata map 410 may correspond to advertisements in paginated electronic content 420 to be viewed on a screen of the electronic reader device 170. For example, the paginated electronic content 420 may depict the thirteen (13) advertisements (e.g., “A” through “M”) and how they are placed within each of the eleven (11) pages.

While may of the paginated electronic content 420 may have room for only one advertisement, it should be appreciated that one or more additional electronic advertisement content may also be displayed with the advertisement on the same page. Moreover, the advertisement may be viewed concurrently with other non-advertisement content.

An advantage of providing an advertisement metadata map configuration 400 may be to provide a way to place and present advertisements on electronic devices, e.g., electronic reader devices. As discussed above, electronic reader content may have unique specifications differing than those of web-style content. As a result, an advertisement metadata map configuration 400 may optimize advertisement placement for paginated electronic content for electronic reader devices. Therefore, for all intended purposes, advertisements in electronic reader format may have a similar effect on a consumer viewing the advertisement in a traditional format or in a web-style layout.

In some embodiments, the advertisement metadata map configuration 400 may effectively function like a “playlist.” The playlist may list and map advertisements that may be displayed with various paginated materials. A benefit of such a feature is offline advertisement placement. For example, a unique feature of some electronic reader devices, e.g., electronic paper display having electrophoretic displays or electro-wetting displays, may be that when the device is powered off, a persistent display (e.g., an EPD) may still be provided even though the device is not powered. Because of this unique feature, presenting electronic content, including advertisements, may be an important feature to utilize. Not only is battery life enhanced, but advertisements may be more effectively targeted to consumers and may have a high viewing probability. Therefore, using an advertisement metadata map configuration 400 may provide a way for an electronic reader device to preload advertisements and place advertisements when the device is offline or even when the device is powered down.

In other embodiments, since the advertisement metadata map 410 may have various information of one or more advertisements, these parameters/categories may be useful in targeting customers. For example, sports-related advertisements may be incorporated within sports-related electronic content.

It should also be appreciated that user profiling may also be provided to improve advertisement targeting. For example, a user of an electronic reader device may subscribe to one or more various electronic content. Based on his or her selections, advertisements related to his or her selections may be inserted into electronic content at the device. The user may also have reading habits that may be tracked and recorded. For instance, even though a user may subscribe to a wide variety of electronic content, it may be determined that the user only reads content related to entertainment and music. Therefore, even when the user is viewing electronic content related to business or sports, advertisements may still be directed to entertainment and/or music because of his past history and/or habits. In other words, the CDN 100 may provide an intelligent and dynamic platform to target customers with specific advertisements when using the advertisement metadata map configuration 400 discussed above. It should be appreciated that such profiling may be achieved at the end user device, at one or more components of the CDN 100, or a combination thereof.

Although presentment of these electronic advertisements, as described above, do not depend on general topic/subject a particular user chooses to read/consume, acquiring information relating to displayed electronic content may be used to enhance size, placement, and/or associated costs of advertisements. For example, when electronic content (e.g., an advertisement) is displayed at an electronic device, information relating to the displayed content may be acquired. The information may include time of day/week/year of display, duration of display, geographical location(s) of electronic device during display, location of displayed electronic content on a screen, number of times displayed, and/or any related user actions to the displayed content. It should be appreciated that the related user actions may include clicking a hyperlink, calling the advertiser if device is suitably equipped for making calls, bookmarking the advertisement, forwarding the advertisement to one or more friends, printing the advertisement, etc. This information may be used to determine habits/trends of a user, for example, which may be used to further determine its effectiveness and/or associated price/cost. In some embodiments, this information may be stored and processed by the advertisement module 200 to determine what advertisements to display and how/where to present them.

It should be appreciated that the electronic advertisement content may be passive and/or active. Passive advertisements may be static text and images. Active advertisements may include animated text and/or images, similar to an animated GIF. Active advertisements may also include one or more hyperlinks and/or other interactivity options with which a user may interact. For example, an active advertisement may include a hyperlink for a user to click/select in order to retrieve more information about the advertisement. Another example may include a user selecting an option within an advertisement that allows the user to physically print out a coupon from a printer communicatively coupled to the user's electronic device. Other interactive features may include ordering of an advertised item directly from the electronic device, receiving directions to a local store, etc. Other various embodiments to preserve or replicate traditionally presented advertisement content may also be provided.

Using the mapping feature describe above also optimized file size and minimized cost of delivery over networks. Because a mapping or playlist is established, file transfer may be achieved so as to minimize network overload.

In addition, using a mapping scheme to place advertisement in electronic content may provide advertisers with a new tool for adhering to advertisement campaign paradigms. For instance, an advertiser may use a series of advertisements that are meant to run in sequence for its full effect. Utilizing and configuring a mapping regime may help advertisers expand marketing, especially for those using electronic reader devices.

By presenting and placing advertisements using metadata maps, preservation and effect of traditional advertisements may be provided. In addition to the benefits described above, embodiments of the system and method for presenting electronic advertisement content using metadata maps not only provide an effective and improved technique for offering and selling products, but also may allow advertisers to more effectively service the consumer pool without any additional work. Moreover, advantages in business and marketing strategies may also become increasingly apparent. These benefits and opportunities may not otherwise be provided by conventional advertising techniques in electronic reader devices, which may typically reduce a full-page traditional advertisement, require scrolling or other cumbersome navigation features, and ultimately decrease its original effect on consumers.

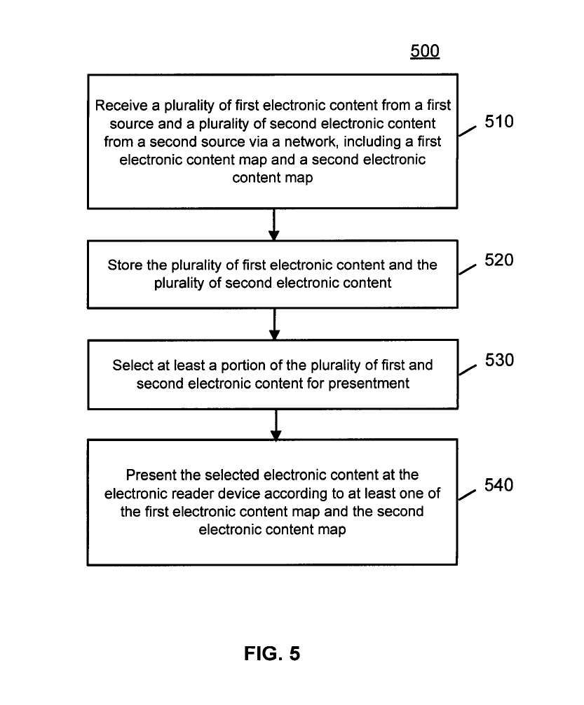

FIG. 5 depicts an illustrative flowchart for presenting and placing content at an electronic device, according to an exemplary embodiment. The exemplary method 500 is provided by way of example, as there are a variety of ways to carry out methods disclosed herein. The method 500 shown in FIG. 5 may be executed or otherwise performed by one or a combination of various systems. The method 500 is described below as carried out by at least system 100 in FIG. 1 and/or module 200 in FIG. 2, by way of example, and various elements of system 100 and module 200 are referenced in explaining the example method of FIG. 5. Each block shown in FIG. 5 represents one or more processes, methods, or subroutines carried in the exemplary method 500. A computer readable media comprising code to perform the acts of the method 500 may also be provided. Referring to FIG. 5, the exemplary method 500 may begin at block 510.

At block 510, an acquisition module 202 may be configured to receive via a network a plurality of first electronic content from a first source and a plurality of second electronic content from a second source. The plurality of first electronic content may comprise a first electronic content map and the plurality of second electronic content may comprise a second electronic content map. The plurality of first electronic content may comprise non-advertisement content and the plurality of second electronic content may comprise advertisement content.

The first electronic content map may be a metadata map for paginating the plurality of first electronic content. The first electronic content map comprises at least one of the following categories: page number, type, chapter, section, depth, duration, and size.

The second electronic content map may be a metadata map for placement of the plurality of second electronic content. The second electronic content map comprises at least one of the following categories: content number or identification, page, type or category, duration, and size.

At block 520, a storage module 204 may be configured to store the plurality of first electronic content and the plurality of second electronic content. At block 530, a selection module 206 may be configured to select at least some of the plurality of first electronic content and the plurality of second electronic content for presentation.

At block 540, a presentation module 208 may be configured to present the selected electronic content at the electronic reader device according to at least one of the first electronic content map and the second electronic content map. The presentation module may be configured to present the selected electronic content at the electronic reader device in an offline mode. The presentation module 208 may fit the electronic content in an entire display portion of the electronic reader device. In other embodiments, the presentation module 208 may fit the electronic content in at least a display portion of the electronic reader device.

When the present module 208 presents the electronic content, the spatially and temporally persistent component may be related in content to the spatially persistent and temporally transient component. In some embodiments, the spatially and temporally persistent component presents electronic content in a persistent frame. In other embodiments, the spatially persistent and temporally transient component may optimize presentment of the selection electronic content. For example, the spatially persistent and temporally transient component may dynamically present the electronic content. As described above, the selected electronic content may be presented in sequential or random order.

It should be appreciated that while embodiments are directed to at least one spatially and temporally persistent component and at least one spatially and temporally transient component, other various embodiments may also be provided. For example, the advertisement may include a spatially transient and temporally persistent and/or a spatially persistent and temporally transient component. Other various embodiments may also be provided.

While the features and functionalities of the systems and methods are primarily directed to electronic advertisements, it should be appreciated that the features and functionalities of may be applied to other content as well. Furthermore, while the advertisement content is described primarily in a visual display, it should be appreciated that the content may include multimedia, audio, and/or other presentments.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A system for presenting content at an electronic reader device, comprising:
an acquisition module configured to receive via a network a plurality of first electronic content from a first source and a plurality of second electronic content from a second source, wherein the plurality of first electronic content includes a first electronic content map and the plurality of second electronic content includes a second electronic content map;
a storage module configured to store the plurality of first electronic content and the plurality of second electronic content t;
a selection module configured to select at least some of the plurality of first electronic content and the plurality of second electronic content for presentation; and
a presentation module configured to present the selected electronic content at the electronic reader device according to at least one of the first electronic content map and the second electronic content map.

2. The system of claim 1, wherein the plurality of first electronic content comprises non-advertisement content and the plurality of second electronic content comprises advertisement content

3. The system of claim 1, wherein the first electronic content map comprises a metadata map for paginating the plurality of first electronic content.

4. The system of claim 1, wherein the first electronic content map comprises at least one of the following categories: page number, type, chapter, section, depth, duration, and size.

5. The system of claim 1, wherein the second electronic content map comprises a metadata map for placement of the plurality of second electronic content.

6. The system of claim 1, wherein placement comprises at least of page sequence, page location, output size, duration, and page category.

7. The system of claim 1, wherein the second electronic content map comprises at least one of the following categories: content number or identification, page, type or category, duration, and size.

8. The system of claim 1, wherein the presentation module is configured to present the selected electronic content at the electronic reader device in an offline mode.

9. A method for presenting content at an electronic reader device, comprising:
receiving, at an acquisition module, via a network, a plurality of first electronic content from a first source and a plurality of second electronic content from a second source, wherein the plurality of first electronic content includes a first electronic content map and the plurality of second electronic content includes a second electronic content map;
storing, at a storage module, the plurality of first electronic content and the plurality of second electronic content;
selecting, at a selection module, at least some of the plurality of first electronic content and the plurality of second electronic content for presentation; and
presenting, at a presentation module, the selected electronic content at the electronic reader device according to at least one of the first electronic content map and the second electronic content map.

10. The method of claim 9, wherein the plurality of first electronic content comprises non-advertisement content and the plurality of second electronic content comprises advertisement content

11. The method of claim 9, wherein the first electronic content map comprises a metadata map for paginating the plurality of first electronic content.

12. The method of claim 9, wherein the first electronic content map comprises at least one of the following categories: page number, type, chapter, section, depth, duration, and size.

13. The method of claim 9, wherein the second electronic content map comprises a metadata map for placement of the plurality of second electronic content.

14. The method of claim 9, wherein placement comprises at least of page sequence, page location, output size, duration, and page category.

15. The method of claim 9, wherein the second electronic content map comprises at least one of the following categories: content number or identification, page, type or category, duration, and size.

16. The method of claim 9, wherein the presentation module is configured to present the selected electronic content at the electronic reader device in an offline mode.

17. A computer readable medium comprising code to perform the acts of the method of claim 9.
